(19) United States
(12) Patent Application Publication
(10) Pub. No.: US 2012/0179392 A1
(43) Pub. Date: Jul. 12, 2012

(54) METHOD AND SYSTEM FOR MEASURING STRAIN IN TWISTED CORD

(75) Inventor: Paul Zakelj, Stow, OH (US)

(73) Assignee: BRIDGESTONE AMERICAS TIRE OPERATIONS, LLC, Nashville, TN (US)

(21) Appl. No.: 13/004,164

(22) Filed: Jan. 11, 2011

(51) Int. Cl. G01N 3/08; H04N 7/18; G06F 19/00

(52) U.S. Cl. 702/43; 73/826; 348/135; 348/E07.085

(57) ABSTRACT

A method for measuring strain in a twisted cord is provided. The method includes the step of securing the ends of the twisted cord in respective cord grips in an initial state and taking a first digital image of at least a portion of the twisted cord in the unloaded state. Image data of the first image is analyzed to determine the number of twists per unit length in the first digital image. A load is applied to the twisted cord. A second digital image of at least a portion of the loaded twisted cord is then taken. The image data of the second image is analyzed to determine the number of twists per unit length in the second digital image. A parameter of the tensioned twisted cord is calculated using the number of twists per unit length in first digital image and the number of twists per unit length in the second digital image.

### BACKGROUND OF THE INVENTION

Twisted cords are a component used in the main body, or casing, of motor vehicle tires. In particular, tire casings incorporates fabrics of polyester, nylon or rayon cords with in the casing rubber compound. These cords are commonly twisted to improve their strength. As part of the tire design and manufacturing process, these cords are subject to various tests to determine their properties under different operating conditions. One common test determines the strain on the twisted cords under various conditions. Such strain tests are commonly performed using a test rig that includes a pair of cord grips at least one of which is movable relative to the other. To perform a test, an end of twisted cord test specimen in placed in each of the cord grips and then the at least one cord grip is moved relative to the other in order to apply a force, or tension, on the twisted cord.

During these tests, the strain on the twisted cord is measured as the change in length of the twisted cord divided by the original length of the twisted cord. The length of the twisted cord is measured as the length between the ends captured in the two cord grips. Thus, the distance between the two cord grips is theoretically equivalent to the length of the twisted cord and is used as a stand-in for cord length in the strain calculation. Unfortunately, there are some problems with this testing method. For example, with many cord grip designs, it can be difficult to determine the precise point at which the twisted cord transitions from being in the cord grip to being between the cord grips. This can lead to ambiguity in measurements of the distance between the cord grips. Additionally, the twisted cord can slip in one or both of the cord grips when the strain is applied. When this slippage occurs, the cord grips move farther apart than the actual distance that the twisted cord has been stretched. Because the distance between the cord grips is no longer equivalent to the strained length of the twisted cord, the strain measurement is inaccurate. Moreover, whether any slippage occurred and the amount of slippage is very difficult to determine making the magnitude of the inaccuracy in the strain measurement hard to estimate. Further, during strain testing at elevated temperatures, expansion of the metal parts in the cord grips can introduce more ambiguity into the strain measurements. The behavior of the twisted cord in the area of the cord grips is not well known. As a result, there can be significant uncertainty regarding the accuracy of the strain measurements using this method.

### BRIEF DESCRIPTION OF THE SEVERAL VIEWS OF THE DRAWING(S)

FIG. 1 is a schematic view of an exemplary system for measuring strain in twisted cords in accordance with the invention.

FIG. 2 is a flow chart of an exemplary method for measuring strain in twisted cords in accordance with the invention.

### DETAILED DESCRIPTION OF THE INVENTION

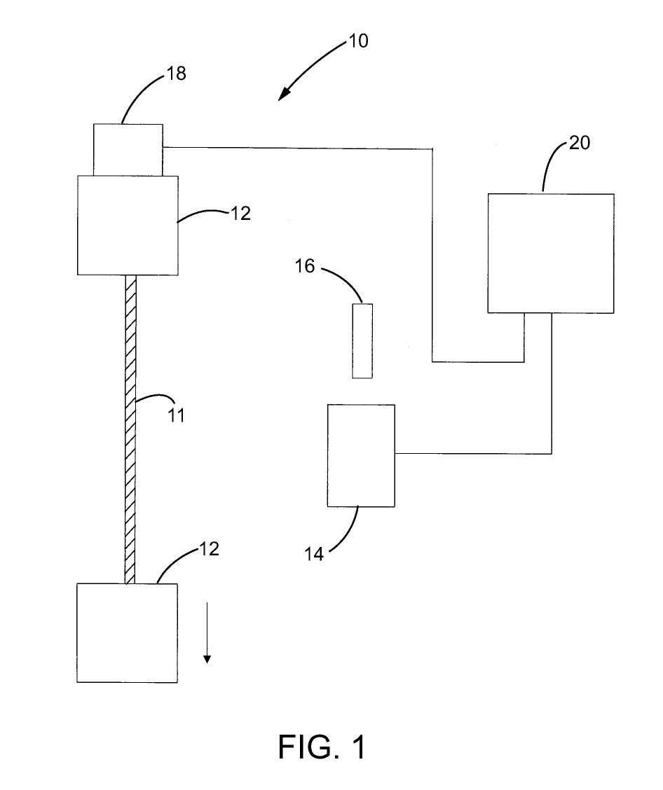

Referring to FIG. 1 of the drawings, an exemplary embodiment of a strain testing system 10 according to the invention is schematically shown. The illustrated testing system 10 includes a pair of spaced cord grips 12 each of which is configured to grip an end of a twisted cord test specimen 11. The twists in the cord are shown in exaggerated fashion in FIG. 1 for illustrative purposes. In a known manner, at least one of the cord grips 12 is movable relative to the other cord grip 12 in order to apply a tension force on the twisted cord 11. The twisted cord specimen 11 can be any type of twisted cord, however, the invention has particular applicability, and is described in connection with, the testing of polyester, nylon and rayon twisted cords that are used in the casings of vehicle tires. The invention can also be used in the testing of twisted steel cords used in the belts of vehicle tires.

In order to determine the strain on the twisted cord test specimen 11 that results from moving the at least one cord grip, the system 10 is configured to optically measure the number of cord twists per unit length in both the original un-tensioned state and in the tensioned state. As the tension increases, the cord 11 undergoes positive strain and elongates. This decreases the number of twists per unit length. The change in twists per unit length is directly related to strain as described in more detail below. To this end, the system 10 includes a digital camera 14 for producing image data reflective of the number of twists in at least a segment of the twisted cord 11 held in the cord grips 12. The digital camera 14 preferably can be fixed in a desired position and is oriented such that the cord 11 is either horizontal or vertical in the image produced by the camera 14. As will be understood by those skilled in the art, any standard machine vision camera could be used as the digital camera 14 in the system 11.

The relationship between strain and the number of twists per unit length can be explained as follows:

Given a unit length of 1024 pixels, which corresponds to the image height;

Original Length: TW₀=number of twists/1024 pixels;

Original pixels/twist: L₀=1024 pixels/number of twists;

Strained Length: TW₁=number of twists/1024 pixels;

Strained pixels/twist: L₁=1024 pixels/number of twists;

Strain=(L₁−L₀)/L₀=(L₁/L₀−L₀/L₀)=L₁/L₀−1;

Substituting 1/TW for L;

Strain=TW₀/TW₁−1

Thus, for a twisted cord test specimen: Strain=Original Number of Twists/Strained Number of Twists −1. Using this formula, strain can be determined from analyzing the image data of the twisted cord so as to determine the number of twists shown in the image.

Advantageously, because the system 10 can be setup to measure the number of cord twists in a segment of the twisted cord 11 between the cord grips 12 that is not held by the cord grips, the system 11 can eliminate the ambiguities in the test results that are caused by slippage in the cord grips when cord grip spacings are used to determine original and strained cord lengths. In this respect, the system 10 and testing method of the invention can be completely non-contacting. Moreover, unlike some non-contacting strain measurement methods, the system 10 and method of the invention do not require gauge marks or targets to be applied to the twisted cord 11. The twisted cords being tested are typically quite narrow making it difficult to apply such marks and the need to apply marks in preparation for testing can make the testing process much more complicated and time consuming. Moreover, the solvents used in the marking process may alter the properties of the twisted cord being tested.

To facilitate the capture of a digital image of sufficient quality, the system 10 can include a light source 16, as shown in FIG. 1, that provides even illumination along the entire length of the twisted cord test specimen 11 or at least the portion of the cord being imaged by the digital camera 14. According to one preferred embodiment, the background is kept as dark as possible so that only the twisted cord 11 is visible in the digital image and a line light source 16 is used to illuminate the cord from the front side. A rectangular LED array light source could also be used for illumination.

The digital camera 14 should have an appropriate lens and filter to produce the desired image quality. Considerations concerning the selection of a lens include the distance between the camera 14 and the twisted cord test specimen 11 and the length of the twisted cord 11 that is being imaged. For instance, if the testing is going to be performed at elevated temperature inside of an oven, the camera 14 may need to be arranged outside of the oven, which may require the camera to be at a greater distance from the test specimen 11. When doing measurements inside of an oven, the light source can be arranged inside or outside of the oven.

For providing data that reflects the force or tension applied on the twisted cord test specimen 11 held in the cord grips 12, the system 10 can include a force sensor 18 configured and arranged to measure the force applied on the twisted cord 11. In the illustrated embodiment, the force sensor 18 comprises a load cell that is arranged in proximity to one of the cord grips 12. Those skilled in the art will appreciate that other methods and arrangements can be used to determine the force applied on the twisted cord.

In order to process the image data produced by the digital camera 14, the system includes a data processor, in this case a computer 20, that is in communication with the digital camera 14. The computer 20 is configured to take the image data associated with individual images taken by the digital camera 14 and process the data so as to produce a measurement of the number of cord twists shown in the image. The computer 20 can then use the number of cord twists to calculate strain on the twisted cord 11. In particular, as noted above, the strain can be determined by analyzing an image taken by the digital camera 14 before a tension is applied to the twisted cord 11 and an image taken after the desired tension is applied to the twisted cord 11. In each case, the computer 20 analyzes the image data to determine the number of cord twists per unit length shown in the image of the twisted cord 11. Assuming the unit length used is the same in the un-tensioned and tensioned images, the strain can be calculated from a ratio of the number of twists determined by the computer 20 from the original un-tensioned image to the number of twists determined by the computer 20 from the tensioned image. As will be appreciated by those skilled in the art, a slight pretension or load must be applied to the twisted cord in order to remove any slack and ensure that the twisted cord is straight.

The force sensor 18 can also be in communication with the computer 20, as shown in FIG. 1, so that data reflective of the force applied on the twisted cord 11 by the cord grips 12 can be collected by the computer 20 and associated with the data relating to the number of twists per unit length shown in the image. The data regarding the number of twists shown in each image, as well as the force data, can be stored in memory for later review and/or further analysis. As will be appreciated any suitable memory in which data can be stored can be used including internal or external hard drives. The computer 20 can also be used to automate movement of the cord grips 12 or alternatively a separate controller can be provided for the cord grips 12 or the movement of the cord grips 12 can be executed manually.

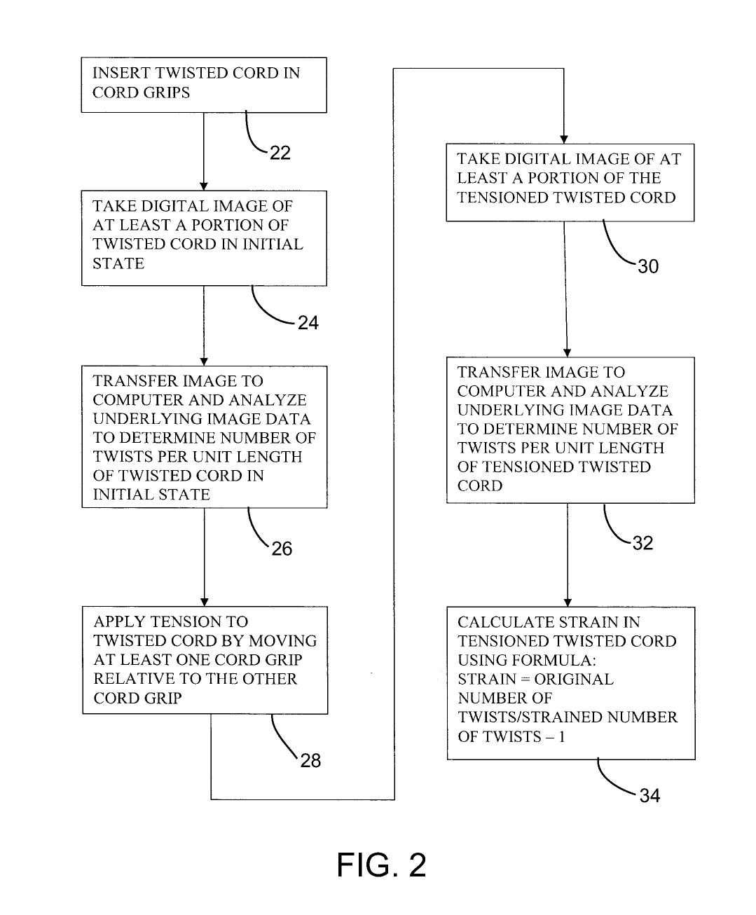

The steps of an exemplary testing method according to the invention, which can be performed using the testing system 10 of FIG. 1, are shown in the flow of FIG. 2. In the method, a twisted cord test specimen 11 is first secured in the cord grips 12 in step 22 and initial image is taken using the digital camera 14 before the twisted cord 11 is tensioned in step 24. The data relating to this image is transferred to the computer 20 where it is processed to determine the number of twists per unit length in the un-tensioned twisted cord in step 26. Tension is then applied to the twisted cord 11 by moving one of the cord grips 12 further away from the other in step 28. Next, an image is taken of the tensioned twisted cord 11 and the data relating to that image is transferred to the computer 20 in step 30. The computer 20 processes the data to determine the number of twists per unit length in the tensioned twisted cord 11 in step 32. The number of twists per unit length in the un-tensioned and tensioned states of the twisted cord 11 is used to determine strain in step 34. The steps of imaging of the tensioned twisted cord (step 30), determination of the number of twists per unit length (step 32) and calculation of strain using this and the un-tensioned number of twists per unit length from the original photo (step 34) can then be repeated as desired to determine the strain reaction over time. Alternatively, if a cyclic load is applied, the step of tensioning the twisted cord (step 28) can be repeated after releasing the initial tension before repeating steps 30, 32 and 34.

The system and method of the present invention can be used to perform a variety of different strain related tests including creep tests and hysteresis loss tests involving cyclic loading and unloading of a twisted cord. These tests can be short or long term. Advantageously, the system and method of the present invention can be configured to gather and analyze the image data quickly enough so that dynamic strain testing can be conducted. For example, the system 10 can be configured to operate in a 20-30 Hz frequency range, i.e. gathering and analyzing 20-30 images per second. Those skilled in the art will understand that a variety of different methods may be used to program the computer 20 to analyze the image data to determine the number of twists per unit length shown in the image. According to one preferred embodiment, the computer 20 can be programmed to employ a fast Fourier transform (FFT) based analysis of the image pixel lines to calculate the number of cord twists per unit length. This method is particularly advantageous because it can analyze the image data very rapidly while still producing a very accurate count of the number of twists in a particular image.

According to one preferred embodiment, National Instruments PXI hardware (available from National Instruments Corp. of Austin, Tex.) is used for acquiring the image data and transferring it to the computer and LabVIEW software (also available from National Instruments) is used for analysis of the data. The MathScript node within LabVIEW provides one method for analyzing the image data so as to determine the number of twists in the image. One example of the steps that can be set-up using MathScript are set forth below. These steps were developed using MATLAB software (available from MathWorks, Inc. of Natick, Mass.) but can be implemented using MathScript in LabVIEW:
a. A region of interest of the image is selected along the axis of the twisted cord image and a fraction of the cord width, for example, 1024×11 pixels.
b. The number of FFT points (NFFT) is selected with a higher number producing greater precision.
c. Each 1024×1 linear section of the 1024×11 rectangular array is processed:
   i. 8-bit image values are converted to double precision values using double.m.
   ii. Linear trends are removed using detrend.m.
   iii. Apply window using hann.m for FFT processing.
   iv. Calculate the FFT using fft.m.
   v. Convert fft result (Y) to single-sided spectrum using (2*abs(Y{1:NFFT/2})).̂2.
   vi. Calculate the linear twist density (frequency) array F=ImageHeight/2*linspace(0,1-2/NFFT, NFFT/2).
   vii. Find the liner twist density values that corresponds with the fft amplitude F(find(log 10(Y)==max(log 10(Y)))).
d. This produces 11 linear twist density values. From this a final linear twist density value to be used must be determined.
   i. One way in which to do this is to use the average of the 11 linear twist density values. However, some of the values may be erroneous due to non-optimal imaging results and thus would contaminate the result.
   ii. Another method is to convert all of the values to a desired precision (for example, 4 decimal places) and then select the predominate value as the results such as by using the following:
      1. Lines_mmx=num2str(TO(50:60)‘,’%6.4f)
      2. x=str2num(Lines_mmx);
      3. y=tabulate(x)
      4. Lines_mmFinal=y(1)

Other FFT based LabVIEW functions that could also be used to analyze the image data to determine the number of twists in the image include FFT Spectrum (Mag-Phase), FFT Power Spectrum, Extract Single Tone Information and Tone Measurements Express. A non-FFT based function that could be used is Signal Operation. To use the latter function, the image data signals need to be relatively clean. This may require the signals to be filtered to remove higher frequency noise and possibly a low frequency undulation if the cord is not uniformly illuminated or uniformly reflective. With a clean signal, the Signal Operation function would provide the position or spacing of the peaks and/or valleys. The average of the spacings would be the cord twist density. As will be appreciated by those skilled in the art, the selection of function can involve a trade-off between computational speed or the availability of input or output parameters.

While the present invention has been disclosed and described in connection with the testing of twisted cords used in body casings of motor vehicle tires, those skilled in the art will appreciate that system and method of the present invention is also applicable to the testing of twisted cords used in applications other than tires.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for measuring strain in a twisted cord comprising the steps of:
securing the ends of the twisted cord in respective cord grips in an unloaded state;
taking a first digital image of at least a portion of the twisted cord in an initial state, the first digital image including first image data;
analyzing the first image data to determine the number of twists per unit length in the first digital image;
applying a load to the twisted cord through the cord grips;
taking a second digital image of at least a portion of the loaded twisted cord, the second digital image including second image data;
analyzing the second image data to determine the number of twists per unit length in the second digital image; and
calculating a parameter descriptive of the twisted cord using the number of twists per unit length in first digital image and the number of twists per unit length in the second digital image.

2. The method of claim 1 wherein the analyzing of the image data to determine the number of twists per unit length includes using Fast Fourier Transforms.

3. The method of claim 1 further including the step of sensing the force applied on the loaded twisted cord.

4. The method of claim 3 further including the step of associating the sensed force with the calculated parameter descriptive of the twisted cord.

5. The method of claim 4 further including the step of saving the calculated parameter descriptive of the twisted cord and the sensed force in memory.

6. The method of claim 1 wherein the load applied to the twisted cord is a tension.

7. The method of claim 6 wherein the tension is applied by moving at least one of the cord grips relative to the other cord grip.

8. The method of claim 1 wherein the parameter descriptive of the twisted cord is strain.

9. A system for measuring strain in a twisted cord comprising:
a first cord grip for securing a first end of the twisted cord;
a second cord grip for securing a second end of the twisted cord, wherein the cord grips are configured to apply a load on the twisted cord;
a force sensor arranged and configured to sense a force applied to a twisted cord held in the first and second cord grips and produce force data;
a digital camera arranged to take an image of a twisted cord held in the first and second cord grips, the image taken by the digital camera including underlying image data; and
a data processor in communication with the digital camera and the force sensor, the data processor being configured to analyze the underlying image data from the digital camera and determine a number of twists per unit length in the image and to calculate a parameter descriptive of the twisted cord using the number of twists per unit length in an image of a twisted cord in an initial state and an image of the twisted cord in a loaded state.

10. The system of claim 9 wherein the data processor is configured to analyze the underlying image data from the digital camera using Fast Fourier Transforms.

11. The system of claim 9 further including a light source.

12. The system of claim 9 wherein the data processor is a computer.

13. The system of claim 9 wherein the data processor is configured to associate the force data with the calculated parameter.

14. The system of claim 9 wherein the cord grips are configured to apply a load to the twisted cord by moving at least one of the cord grips relative to the other cord grip.

15. The system of claim 9 wherein the parameter descriptive of the twisted cord is strain.
